(19) United States
(12) Patent Application Publication
(10) Pub. No.: US 2015/0217317 A1
(43) Pub. Date: Aug. 6, 2015

(54) COLOR-CHANGER

(71) Applicant: ABB TECHNOLOGY AG, Zurich (CH)

(72) Inventor: Arnulf Krogedal, Sandnes (NO)

(21) Appl. No.: 14/631,277

(22) Filed: Feb. 25, 2015

Related U.S. Application Data
(63) Continuation of application No. PCT/EP2013/002425, filed on Aug. 13, 2013.

(30) Foreign Application Priority Data
Sep. 12, 2012 (EP) 12006408.4

(51) Int. Cl. B05B 12/14; G01M 3/28; B05B 12/00

(52) U.S. Cl. CPC B05B 12/149; B05B 12/006; B05B 12/1409; G01M 3/2876

(57) ABSTRACT

A color-changer includes an output-channel having an outlet for paint material, and paint-supply-channels leading to the output-channel. The paint-supply channels are each respectively switchable by a corresponding first valve component. The first valve components are pilotable by a pressured fluid which is conducted through a corresponding pressure-line each having a corresponding inlet. One common, switchable pressure-supply-outlet is alternatively connectable with one of the inlets of the pressure-lines so that at most one of the corresponding first valve components is switchable at the same time. The present disclosure also provides a method for determining the leakage of the first valve component of the color-changer.

### RELATED APPLICATIONS

This application claims priority as a continuation of PCT/EP2013/002425, which was filed as an International Application on Aug. 13, 2013, and which claims priority to EP 12006408.4, filed on Sep. 12, 2012. The entire contents of these applications are hereby incorporated by reference in their entireties.

### FIELD

The present disclosure relates to a color-changer.

### BACKGROUND INFORMATION

It is known that in industrial paint shops—for example, in the automotive industry—a larger number of paint colors are used. Such paint shops may be robot-based and designed for a number of (e.g., 20 to 30) paint colors and a cycle time of 60 s to 90 s per object, for example, to become painted. A color-changer might be mounted on the arm of a robot and is used to change the current paint color being applied. A color changer is a switchable connection in between one paint output—which is the end of an output channel of a color-changer—and a larger number of different paint-supply-lines which are provided along different paint booths and which are leading to the output channels of other corresponding color-changers. The output of a color-changer is normally connected with an atomizer which is mounted at the end of the robot arm in case of a robot-based paint shop. Other manipulators than robots are also suitable to move an atomizer around an object to be painted.

In between the paint-supply-lines and the output-channel of a corresponding color-changer, valve-means are provided which strictly have to become switched in an alternating manner so that, at a maximum, a channel from one paint-supply-line to the output-channel is open. If there is more than exactly one open channel leading to the output-channel, a mixture of different paint materials with different colors will occur and the paint result on the painted object will be unusable. Even if a control mechanism is provided to prevent a synchronous switching of the valve-means, it is has not been possible to totally exclude the possibility that more than one paint-supply-channel is connected to the output-channel in case of a malfunction of the control-mechanism.

Further, in case there is a leakage in one of the valve-means, a mixture of different paint materials will occur and the paint result will be unusable. A leakage of a valve-means is rather difficult to detect, in most cases only indirectly by detection of an already unusable paint-result. Moreover, a correlation of an unusable paint result to a certain atomizer is not always possible, for example, in case an object is painted by different robots having respectively different atomizers. Thus, a larger time is required to search for the particular defective color-changer.

### SUMMARY

An exemplary embodiment of the present disclosure provides a color-changer which includes an output-channel having an outlet for paint material, a plurality of paint-supply-channels leading to the output channel, and a plurality of first valve-means for switching a corresponding one of the paint-supply-channels, respectively. The exemplary color-changer also includes a plurality of pressure lines each having a corresponding inlet. The pressure lines each respectively lead to one of the first valve-means, which are each respectively pilotable by a pressurized fluid which is conducted through a corresponding one of the pressure lines, respectively. In addition, the exemplary color-changer includes one switchable pressure-supply-outlet which is configured to be alternatively connectable with one of the inlets of the pressure-lines, so that at most only one of the corresponding first valve-means is switchable at the same time. Further, the exemplary color-changer includes a second valve-means at the outlet of the output-channel, and a plunger configured to apply a predetermined pressure-force into the output-channel filled with paint material, where a position of the plunger is determinable.

An exemplary embodiment of the present disclosure provides a method for determining a leakage of valves of a color-changer. The color changer includes an output-channel having an outlet for paint material, a plurality of paint-supply-channels leading to the output channel and connected to corresponding paint-supply-lines, a plurality of first valves for switching a corresponding one of the paint-supply-channels, respectively, and a plurality of pressure lines each having a corresponding inlet, the pressure lines each respectively leading to one of the first valves, which are each respectively pilotable by a pressurized fluid which is conducted through a corresponding one of the pressure lines, respectively. In addition, the color-changer includes one switchable pressure-supply-outlet which is configured to be alternatively connectable with one of the inlets of the pressure-lines, so that at most only one of the corresponding first valves is switchable at the same time, a second valve at the outlet of the output-channel, and a plunger configured to apply a predetermined pressure-force into the output-channel filled with paint material, where a position of the plunger is determinable. The exemplary method includes closing all first and second valves so that the output-channel is completely closed, applying, by the plunger, a constant pressure force into the output-channel filled by paint material; observing a position of the plunger, and generating, by at least one processor of a computer processing device, a warning signal in case of a drift of the position of the plunger.

An exemplary embodiment of the present disclosure provides a method for determining a leakage of valves of a color-changer. The color changer includes an output-channel having an outlet for paint material, a plurality of paint-supply-channels leading to the output channel and connected to corresponding paint-supply-lines, which are operated with a first pressure, a plurality of first valves for switching a corresponding one of the paint-supply-channels, respectively, and a plurality of pressure lines each having a corresponding inlet, the pressure lines each respectively leading to one of the first valves, which are each respectively pilotable by a pressurized fluid which is conducted through a corresponding one of the pressure lines, respectively. In addition, the color-changer includes one switchable pressure-supply-outlet which is configured to be alternatively connectable with one of the inlets of the pressure-lines, so that at most only one of the corresponding first valves is switchable at the same time, and a second valve at the outlet of the output-channel. In addition, the color-changer includes a solvent-supply-line leading to the output-channel, where the solvent-supply-line is operated with a second pressure, which is higher than the first pressure, a third valve for switching the solvent-supply-line, a plunger configured to apply a predetermined pressure-force into the output-channel filled with paint material, where a position of the plunger is determinable, and a pressure-sensor configured to determine a pressure within the output-channel. The exemplary method includes closing all first and second valves, opening the third valve so that a pressure within the output-channel corresponds to the pressure of the solvent-supply-line, closing the third valve so that the output-channel is completely closed, observing the pressure within the output-channel by the pressure sensor, and generating, by a processor of a computer processing device, a warning signal in case of a drift of the observed pressure.

### BRIEF DESCRIPTION OF THE DRAWINGS

Additional refinements, advantages and features of the present disclosure are described in more detail below with reference to exemplary embodiments illustrated in the drawing.

FIG. 1 shows a color-changer according to an exemplary embodiment of the present disclosure.

### DETAILED DESCRIPTION

Exemplary embodiments of the present disclosure provide a color-changer which, on the one hand, prevents any unintended synchronous switching of the valve-means, and which, on the other hand, permits an easy detection of any leakage of the valve-means (e.g., a valve component including a valve). As used herein, the term “valve-means” is embodied by such a valve component including at least one valve.

According to an exemplary embodiment of the color-changer, exactly one switchable pressure-supply-outlet is provided which is alternatively connectable with one of the inlets of the pressure-lines, so that at most one of the corresponding valve-means is switchable at the same time.

Exemplary embodiments of the present disclosure are based on the idea of mechanically excluding synchronous switching of more than one valve-means within the group of valve-means for the paint-supply-lines. By having only one pressure-supply-outlet which can alternately be connected with one of the inlets of the pressure-lines, no more than one valve-means can be actuated to be respectively piloted at the same time. The valve-means are designed in such a way that they are normally in the closed state, for example, by the use of a pressure force of a spring or other similar techniques to ensure that the valve-means is normally in a closed state. In case of pressure within the corresponding and connected pressure-line—which might be filled with air as pressured fluid, for example—a force in the opposite direction than the pressure force of the spring is applied and the valve-means opens.

The connection of the pressure-supply-output and the corresponding inlet of the selected pressure-line includes, on one side, a movement of the pressure-supply-output in such a way that the pressure-supply-output is face to face with the inlet of the selected pressure-line. According to an exemplary embodiment, means are provided to perform an additional docking movement in the axial direction so that after such a docking movement, a sealed connection in between the pressure-supply-output and pressure-line is gained. According to an exemplary embodiment, some seal rings may be provided.

The pressure-supply-output itself is switchable so that it can be turned on and off as desired. According to an exemplary embodiment, a pressurized-air-supply is available in the paint booth, so this can be used as a source for the pressure-supply-output.

According to an exemplary embodiment, the color-changer may be built from a block of metal, for example, wherein the output-channel might be a bore-hole of, for example, 6 mm diameter, to which further bore holes lead for the paint-supply-lines. The present disclosure envisions a modular structure of such a block.

Thus, a safe color changer is provided which physically excludes synchronous switching of more than one valve-means.

According to an exemplary embodiment of the present disclosure, a group of inlets of the pressure-lines are arranged along a circular path, and the pressure-supply-outlet is pivotable along a corresponding circular path, so that a selection of the corresponding inlet of a pressure-line to be connected with the pressure-supply-outlet is realizable by performing a corresponding rotary movement of the pressure-supply-outlet. A circular arrangement provides, in addition to a compact and lightweight design of the color changer, short movement distances for a fast selection of the input of the pressure-lines. A rotary movement requires one degree of freedom in movement so that one drive is sufficient to effect the corresponding movement of the pressure-supply-outlet. A drive could be powered by pressurized air, for example. According to an exemplary embodiment, pressurized air is also suitable to pivot the valve-means. A flexible connection hose used as pressure-line is suitable to compensate any movement in between a fixed pressure-supply and the movable pressure-supply-outlet.

According to an exemplary embodiment of the present disclosure, a group of inlets of the pressure-lines are arranged along a linear path, and the pressure-supply-outlet is moveable along a corresponding linear path, so that a selection of the corresponding inlet of a pressure-line to be connected with the pressure-supply-outlet is realizable by a corresponding linear movement of the pressure-supply-outlet. For a linear movement, only one drive is required in an advantageous way. Of course, variants with more than one degree of freedom in movement of the pressure-supply-outlet are possible, such as a kind of x-y matrix with two degrees of freedom in movement, for example. This also provides a very compact arrangement.

According to an exemplary embodiment of the present disclosure, a second valve-means is provided at the outlet of the output-channel. Thus, it is possible to hermetically close all ducts to and from the output-channel. This arrangement enables, for example, an easy color change within the output-channel whereas the connection to the atomizer is closed. Thus, no mixed color which is produced during a color change can flow to the atomizer connected to the output of the output-channel.

According to an exemplary embodiment of the present disclosure, a solvent-supply-channel leads to the output-channel which is switchable by a corresponding third valve-means. This arrangement enables an easy color-change within the outlet-channel. After closing the valve-means of the proceeding paint material and before opening the valve-means of the subsequent paint material, the output-channel is cleaned by a solvent flowing through it. The solvent flows off from the output-channel either through an open output of the outlet of the output-channel or a certain dump line which can also be switchably connected with the output-channel.

According to an exemplary embodiment of the present disclosure, a pressure sensor is provided for determining the pressure within the output-channel. Such a pressure sensor enables the determination of a possible pressure-drift within the output-channel and can be used as indicator for a possible leakage of one of the valve-means. According to an exemplary embodiment, all channels leading to the output-channel have to be closed for determining such a drift.

An exemplary embodiment of the present disclosure provides a method for determining a leakage of the valve-means of a color changer according to the present disclosure. In the color changer, the paint-supply-channels are connected to corresponding paint-supply-lines operated with at most a first pressure, wherein the solvent-supply-channel is connected to a corresponding solvent-supply-line operated with at least a second pressure, wherein the second pressure is higher than the first pressure. According to an exemplary embodiment, the method can include: closing all first and the second valve-means; opening the third valve means so that the pressure within the output-channel corresponds to the pressure of the solvent-supply-line; closing the third valve means, so that the output-channel is completely closed; observing the pressure within the output-channel by means of the pressure sensor; and generating a warning signal in case of a drift of the measured pressure.

Hence a pressure of the solvent is applied within the output-channel, which is higher than the pressure of the paint-supply-line. Then, all valve means are closed, so that the output-channel is hermetically sealed. In case of a leakage of any of the valve means, the pressure within the output-channel is not constant but there will be a decreasing drift. This drift is an indicator that any of the valve-means is leaking.

According to an exemplary embodiment of the present disclosure, a plunger is provided for applying a certain pressure-force into the filled and closed output-channel. The position of the plunger is determinable. Such a plunger can be used as indicator for a possible leakage of one of the valve-means.

An exemplary embodiment of the present disclosure provides a method for determining a leakage of the valve-means of a color-changer according to the present disclosure, wherein the paint-supply-channels are connected to corresponding paint-supply-lines. According to an exemplary embodiment, the method can include: closing at least all first and the second valve-means so that the output-channel is completely closed; applying a constant pressure force into the filled output-channel by means of the plunger; observing the position of the plunger; and generating a warning signal in case of a drift of the position of the plunger.

Similar to the method described previously, a pressure is applied within the closed output-channel, which is different than the pressure of the paint-supply-line. In case of a leakage of any of the valve means, the pressure within the output-channel will still be constant due to the constant pressure force of the plunger, but the plunger will move in case of any leakage. Such a movement is an indicator that any of the valve-means is leaking.

For both of the above-described methods, evaluation units might be provided. Such evaluation units can include processing circuitry (e.g., a general-purpose processor or an application specific processor) and a non-transitory computer-readable recording medium having a computer program or computer-readable instructions tangibly recorded thereon to be executed by the processing circuitry. As a computing device, the evaluation unit(s) can observe a possible pressure drift respectively affecting movement of the plunger, and generate a warning signal, for example, in case of a detected leakage.

Additional features of exemplary embodiments of the present disclosure are described in more detail below with reference to the drawing.

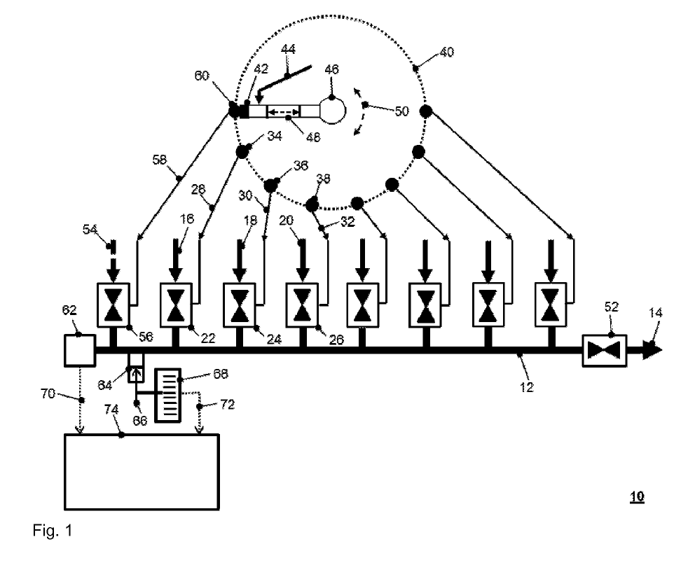

FIG. 1 shows an exemplary embodiment of a color-changer 10 in a schematic view. Several paint-supply-channels 16, 18, 20 lead to an output-channel 12. Each of the paint-supply-channels 16, 18, 20 is respectively switchable by a corresponding valve-means 22, 24, 26 which are closed in their normal state and which are pilotable by applying a pressure force, for example, an air pressure force (e.g., pressurized air), over corresponding pressure lines 28, 30, 32, respectively.

In case one of the valve-means 22, 24, 26 is piloted and open, paint material from a paint-supply-system (not shown) flows into the output-channel 12 and from there through a second valve-means 52 through the output 14 to a paint atomiser (not shown). The second valve-means 52 enables the closing of the output 14 so that no paint can flow to the atomiser in the closed state of the second valve-means 52 as it might be required, for example, during a color-change or a cleaning-process. Such a cleaning process should be done before a new color is filled into the output-channel 12 to prevent any color mismatch of the object to be painted.

In the illustrated exemplary embodiment, a solvent-supply-channel 54 is provided at the rear side of the output-channel 12. The solvent-supply-channel 54 is switchable by a third valve-means 56. In case of a color-change, at least all first valve-means 22, 24, 26 are closed, and afterwards a solvent flows from the solvent-supply-channel 54 into the output-channel 12 and from there through the output 14. After cleaning the output-channel 12, a first valve-means 22, 24, 26 can be opened so that a new paint color flows into the output-channel 12.

The pressure-lines 28, 30, 32 are alternatively connectable with a pressure-supply 44, for example, a supply of pressurized air. Inlets 34, 36, 38 of the pressure-lines 28, 30, 32 are arranged along a circular path 40. By pivoting a docking element 46 in a circular direction as indicated with arrow 50, a switchable pressure-supply-outlet 42 can be positioned face to face to exact one of the inlets 34, 36, 38. An additional docking movement in the axial direction, in this example, performable by a docking cylinder 48, enables a safe connection of the pressure-supply-outlet 42 with at most one of the inlets 34, 36, 38. Thus, only one of the first valve-means 22, 24, 26 can be piloted at the same time.

The solvent-supply-channel 54 and its corresponding third valve-means 56 are constructed similar to the paint-supply-channels 16, 18, 20 and the first valve-means 22, 24, 26, respectively. The third valve-means 56 is piloted by a separate pressure-line 58 which is connectable over its inlet 60 with the switchable pressure supply outlet 42. Thus, it is restricted that the third valve-means 56 and any one of the first valve-means 22, 24, 26 can be opened at the same time.

A pressure-sensor 14 is provided at the rear side of the output-channel 12. In case of applying a certain pressure within the output-channel 12 and closing all valve means 22, 24, 26, 52, 54 leading thereto, the pressure within the output-channel should be constant theoretically. A drift of the pressure is an indicator for a leakage of any of the valve-means 22, 24, 26, 52, 54.

Also, at the rear side of the output-channel—for example, as an alternative solution to the pressure-sensor 62—a plunger 64 is provided. The plunger 64 applies a certain pressure-force 66 into the filled and closed output-channel 12. The pressure within the output-channel 12 will be constant due to the applied constant pressure force.

In case of a movement of the plunger 64, a leakage of one of the valve-means 22, 24, 26, 52, 54 can be assumed. A movement is detectable with determination means 68, which may be optically-based, for example. In accordance with an exemplary embodiment, the determination means 68 includes processing circuitry (e.g., a general-purpose processor or an application specific processor) and a non-transitory computer-readable recording medium having a computer program or computer-readable instructions tangibly recorded thereon to be executed by the processing circuitry to carry out the functions of the determination means 68. The determination means 68 can thus be a computer processing device.

An evaluation unit 74 is connected 70, 72 with the pressure-sensor 62 and/or the plunger 64 and observes a pressure drift and/or a movement of the plunger 64. Since the observation also requires the actual states of the valve-means 22, 24, 26, 52, 54 a connection to an overall control system or—in case of a robot based paint shop—a robot controller might be provided. In accordance with an exemplary embodiment, the evaluation unit 74 includes processing circuitry (e.g., a general-purpose processor or an application specific processor) and a non-transitory computer-readable recording medium having a computer program or computer-readable instructions tangibly recorded thereon to be executed by the processing circuitry to carry out the functions of the evaluation unit 74. The evaluation unit 74 can thus be a computer processing device.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

### LIST OF REFERENCE SYMBOLS

10 exemplary color-changer
12 output-channel
14 output for paint material
16 first paint-supply-channel
18 second paint-supply-channel
20 third paint-supply-channel
22 first first valve-means
24 second first valve-means
26 third first valve-means
28 first pressure-line
30 second pressure-line
32 third pressure-line
34 inlet of first pressure-line
36 inlet of second pressure-line
38 inlet of third pressure-line
40 circular path
42 switchable pressure-supply-outlet
44 pressure-supply
46 pivotable docking element
48 docking cylinder
50 pivoting direction
52 second valve-means
54 solvent-supply-channel
56 third valve-means
58 fourth pressure-line
60 inlet of fourth pressure-line
62 pressure-sensor
64 plunger
66 pressure-force
68 determination means
70 first data line
72 second data line
74 evaluation unit

What is claimed is:

1. A color-changer, comprising:
an output-channel having an outlet for paint material;
a plurality of paint-supply-channels leading to the output channel;
a plurality of first valve-means for switching a corresponding one of the paint-supply-channels, respectively;
a plurality of pressure lines each having a corresponding inlet, the pressure lines each respectively leading to one of the first valve-means, which are each respectively pilotable by a pressurized fluid which is conducted through a corresponding one of the pressure lines, respectively;
one switchable pressure-supply-outlet which is configured to be alternatively connectable with one of the inlets of the pressure-lines, so that at most only one of the corresponding first valve-means is switchable at the same time;
a second valve-means at the outlet of the output-channel; and
a plunger configured to apply a predetermined pressure-force into the output-channel filled with paint material, a position of the plunger being determinable.

2. The color-changer according to claim 1, wherein a group of the inlets of the pressure-lines are arranged along a circular path, and the pressure-supply-outlet is pivotable along a corresponding circular path, such that a selection of a corresponding one of the inlets of the pressure-lines to be connected with the pressure-supply-outlet is realizable by a corresponding rotary movement of the pressure-supply-outlet.

3. The color-changer according to claim 1, wherein a group of the inlets of the pressure-lines are arranged along a linear path, and the pressure-supply-outlet is moveable along a corresponding linear path, such that a selection of a corresponding one of the inlets of the pressure-lines to be connected with the pressure-supply-outlet is realizable by a corresponding linear movement of the pressure-supply-outlet.

4. The color-changer according to claim 1, comprising:
a solvent-supply-channel leading to the output-channel; and
a third valve-means for switching the solvent-supply-channel.

5. The color-changer according to claim 2, comprising:
a solvent-supply-channel leading to the output-channel; and
a third valve-means for switching the solvent-supply-channel.

6. The color-changer according to claim 3, comprising:
a solvent-supply-channel leading to the output-channel; and
a third valve-means for switching the solvent-supply-channel.

7. The color-changer according to claim 1, comprising:
a pressure-sensor configured to determine a pressure within the output-channel.

8. The color-changer according to claim 5, comprising:
a pressure-sensor configured to determine a pressure within the output-channel.

9. The color-changer according to claim 6, comprising:
a pressure-sensor configured to determine a pressure within the output-channel.

10. A method for determining a leakage of valves of a color-changer, wherein the color changer includes:
an output-channel having an outlet for paint material;
a plurality of paint-supply-channels leading to the output channel and connected to corresponding paint-supply-lines;
a plurality of first valves for switching a corresponding one of the paint-supply-channels, respectively;
a plurality of pressure lines each having a corresponding inlet, the pressure lines each respectively leading to one of the first valves, which are each respectively pilotable by a pressurized fluid which is conducted through a corresponding one of the pressure lines, respectively;
one switchable pressure-supply-outlet which is configured to be alternatively connectable with one of the inlets of the pressure-lines, so that at most only one of the corresponding first valves is switchable at the same time;
a second valve at the outlet of the output-channel; and
a plunger configured to apply a predetermined pressure-force into the output-channel filled with paint material, a position of the plunger being determinable, and
wherein the method comprises:
closing all first and second valves so that the output-channel is completely closed;
applying, by the plunger, a constant pressure force into the output-channel filled by paint material;
observing a position of the plunger; and
generating, by at least one processor of a computer processing device, a warning signal in case of a drift of the position of the plunger.

11. The method according to claim 10, wherein the color-changer includes a solvent-supply-channel leading to the output-channel, and a third valve for switching the solvent-supply-channel.

12. A method for determining a leakage of valves of a color-changer, wherein the color changer includes:
an output-channel having an outlet for paint material;
a plurality of paint-supply-channels leading to the output channel and connected to corresponding paint-supply-lines, the paint-supply-lines being operated with a first pressure;
a plurality of first valves for switching a corresponding one of the paint-supply-channels, respectively;
a plurality of pressure lines each having a corresponding inlet, the pressure lines each respectively leading to one of the first valves, which are each respectively pilotable by a pressurized fluid which is conducted through a corresponding one of the pressure lines, respectively;
one switchable pressure-supply-outlet which is configured to be alternatively connectable with one of the inlets of the pressure-lines, so that at most only one of the corresponding first valves is switchable at the same time;
a second valve at the outlet of the output-channel;
a solvent-supply-line leading to the output-channel, the solvent-supply-line being operated with a second pressure, the second pressure being higher than the first pressure;
a third valve for switching the solvent-supply-line;
a plunger configured to apply a predetermined pressure-force into the output-channel filled with paint material, a position of the plunger being determinable; and
a pressure-sensor configured to determine a pressure within the output-channel; and
wherein the method comprises:
closing all first and second valves;
opening the third valve so that a pressure within the output-channel corresponds to the pressure of the solvent-supply-line;
closing the third valve so that the output-channel is completely closed;
observing the pressure within the output-channel by the pressure sensor; and
generating, by a processor of a computer processing device, a warning signal in case of a drift of the observed pressure.
